(19) United States
(12) Patent Application Publication
(10) Pub. No.: US 2006/0134945 A1
(43) Pub. Date: Jun. 22, 2006

(54) Board to board connector assembly

(75) Inventor: Heng-Chen Kuo, Tu-Cheng (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/296,742

(22) Filed: Dec. 7, 2005

(30) Foreign Application Priority Data
Dec. 8, 2004 (CN) 200410077413.6

(51) Int. Cl. H01R 12/00

(52) U.S. Cl. 439/74

(57) ABSTRACT

A board to board connector assembly includes a main board and two secondary boards. The main board includes two connectors abutting each other and is arranged at two opposite surfaces of the main board. Each of the secondary boards includes a connector mating with one of the connectors of the main board.

### BACKGROUND OF THE INVENTION

1. Field of the Invention

The present invention relates to a board to board connector assembly that has a plurality of secondary boards sharing one main board.

2. General Background

The ever increasing density of logic in computer systems has resulted in the development of sub-modules which are basically intermediate size planar printed circuit boards to which smaller components are connected. Each sub-module is connected to a larger main printed circuit board in a face to face relationship. Connections between the sub-module and main board are provided by a plurality of pins projecting normally from the board or sub-module and a socket on the other, the pins being inserted into the socket.

Referring to FIG. 6, a board-to-board connector assembly, disclosed in China patent No. 02248010.2, has a main board 60 and a secondary board 70. The main board 60 forms a female connector 62 and a male connector 63 which are parallel spacing apart from each other. The secondary board 70 also has a male connector and a female connector respectively connected to the female connector 62 and the male connector 63 of the main board 60. However, the female connector 62 and the male connector 63 are so arranged to be parallel to and space apart from each other, that they occupy a relatively large space on the main board 60. In addiction, because the connectors are arranged on one side of the main board 60, when a plurality of secondary boards is needed, the main board had to be larger, therefore cannot meet minimization trend of electronic products.

What is needed is a board to board connector assembly that has a plurality of secondary boards sharing one main board and still meets the minimization trend of electronic products.

### SUMMARY

An exemplary board to board connector assembly includes a main board and two secondary boards. The main board includes two connectors abutting each other and is arranged at two opposite surfaces of the main board. Each of the secondary boards includes a connector mating with one of the connectors of the main board.

Because the connectors are arranged with no space therebetween, when secondary boards are connected to the main board, the dimension of the main board will not increase. Therefore, volume of corresponding electronic product may be reduced. The connectors may be arranged in other ways to change the structure of the main board. A main board can perform different functions by connecting with different secondary boards according to different functional requirements. Thus, product costs and development times are reduced.

Other advantages and novel features will become more apparent from the following detailed description when taken in conjunction with the accompanying drawings, in which:

### BRIEF DESCRIPTION OF THE DRAWINGS

FIG. 1 is an explosive, isometric schematic view of a board to board connector assembly in accordance with a first preferred embodiment of the present invention, the connector assembly includes a main board and a secondary board;

FIG. 2 is an assembled view of FIG. 1;

FIG. 3 is an isometric schematic view of a main board of a board to board connector assembly in accordance with a second preferred embodiment of the present invention;

FIG. 4 is an isometric schematic view of a main board of a board to board connector assembly in accordance with a third preferred embodiment of the present invention;

FIG. 5 is an isometric schematic view of a main board of a board to board connector assembly in accordance with a fourth preferred embodiment of the present invention; and

FIG. 6 is an explosive, isometric schematic view of a conventional board to board connector assembly.

### DETAILED DESCRIPTION OF THE EMBODIMENTS

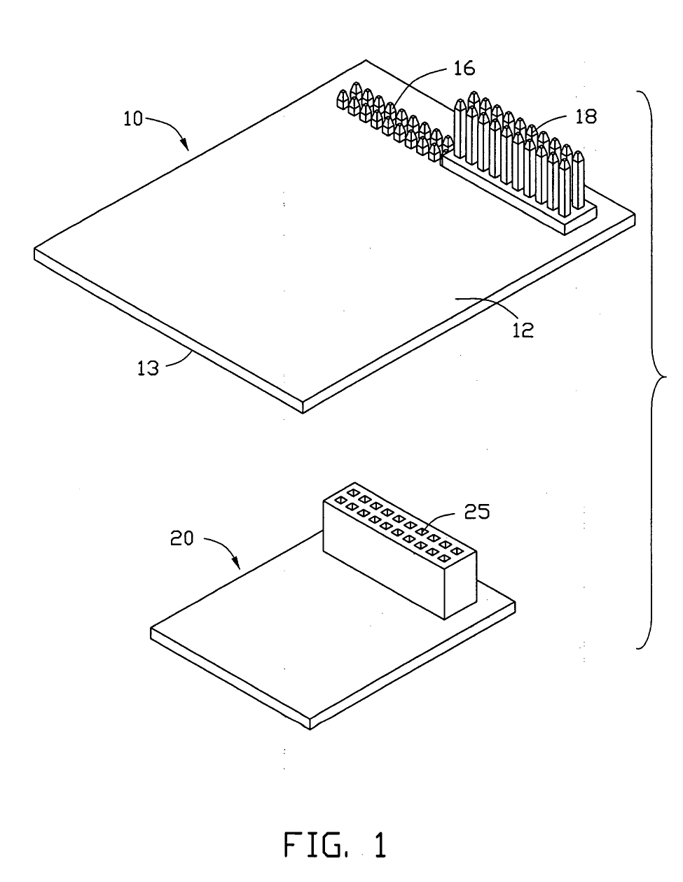

Referring to FIG. 1, a board to board connector assembly in accordance with a first preferred embodiment of the present invention includes a main board 10 and a secondary board 20.

The main board 10 includes a first surface 13 and a second surface 12. The main board 10 and the secondary board 20 are disposed with a plurality of electronic components (not shown). The main board 10 has a male connector 16 mounted to the first surface 13 thereof, and a male connector 18 mounted to the second surface 12 thereof. A short side of the male connector 16 abuts a short side of the male connector 18. The secondary board 20 has a female connector 25 electronically connected thereto.

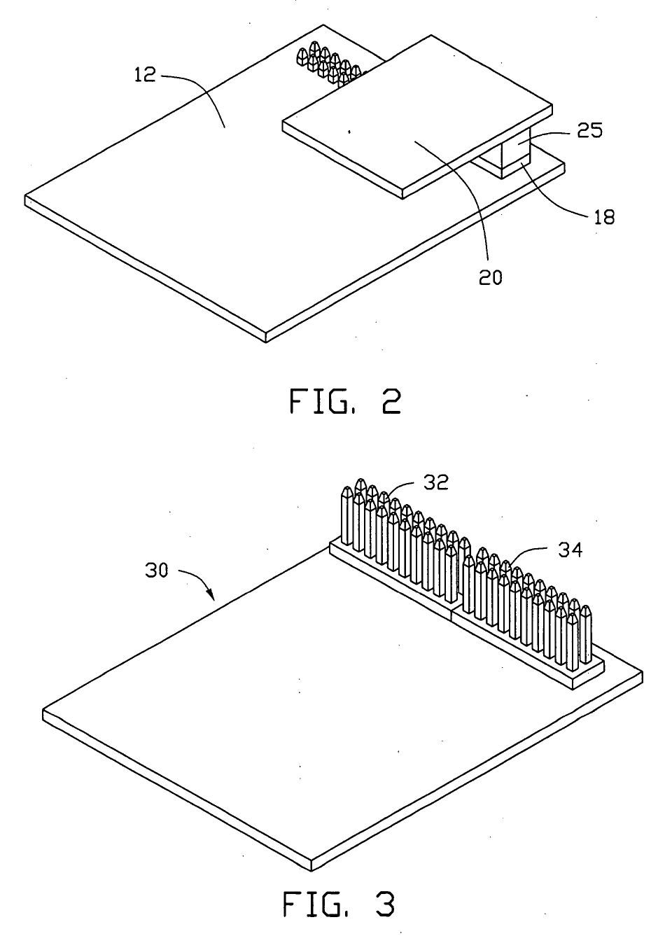

Referring also to FIG. 2, the secondary board 20 is parallel to the main board 10 and faces with the secondary surface 12 of the main board 10. The female connector 25 of the secondary board 20 is coupled to the male connector 18 of the second surface 12 of the main board 10. The first surface 13 of the main board 10 is coupled with another secondary board (not shown).

Because the connectors 16, 18 are arranged with no space therebetween, when secondary boards are connected to the main board, the dimension of the main board 10 will not increase. Therefore, volume of corresponding electronic product may be reduced. The connectors 16, 18 may be arranged in other ways to change the structure of the main board 10. A main board can perform different functions by connecting with different secondary boards according to different functional requirements. Thus, product costs and development times are reduced.

FIG. 3 discloses a main board 30 in accordance with a second preferred embodiment of the present invention. The main board 30 includes two male connectors 32, 34 abutting each other at their short sides. The connectors 32, 34 are arranged on a same surface of the main board 30.

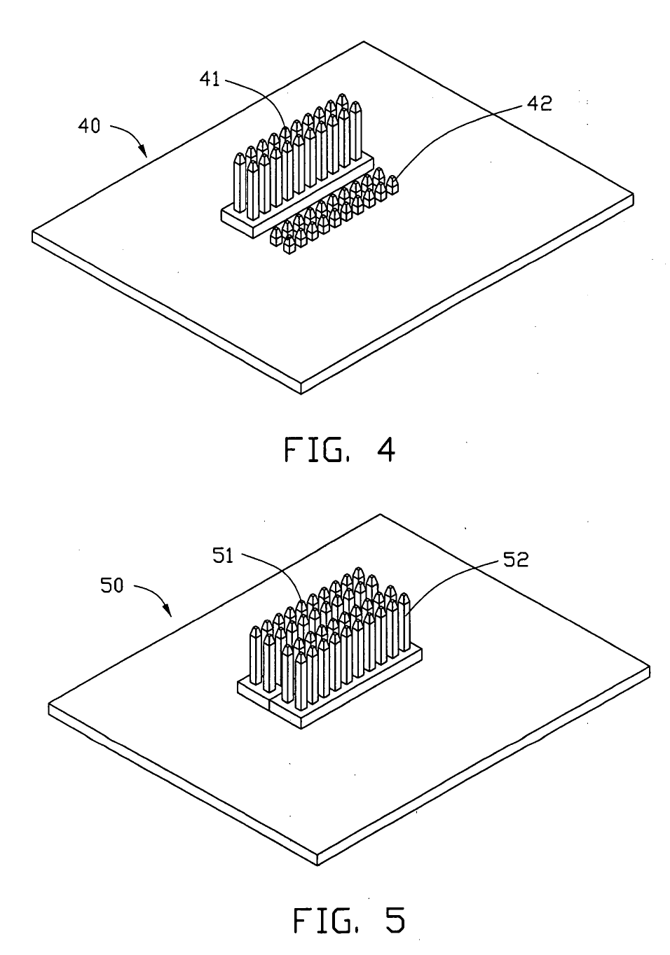

FIG. 4 discloses a main board 40 in accordance with a third preferred embodiment of the present invention. The main board 40 includes two male connectors 41, 42 abutting each other at their long sides. The connectors 41, 42 are respectively arranged on the upper and lower surfaces of the main board 40.

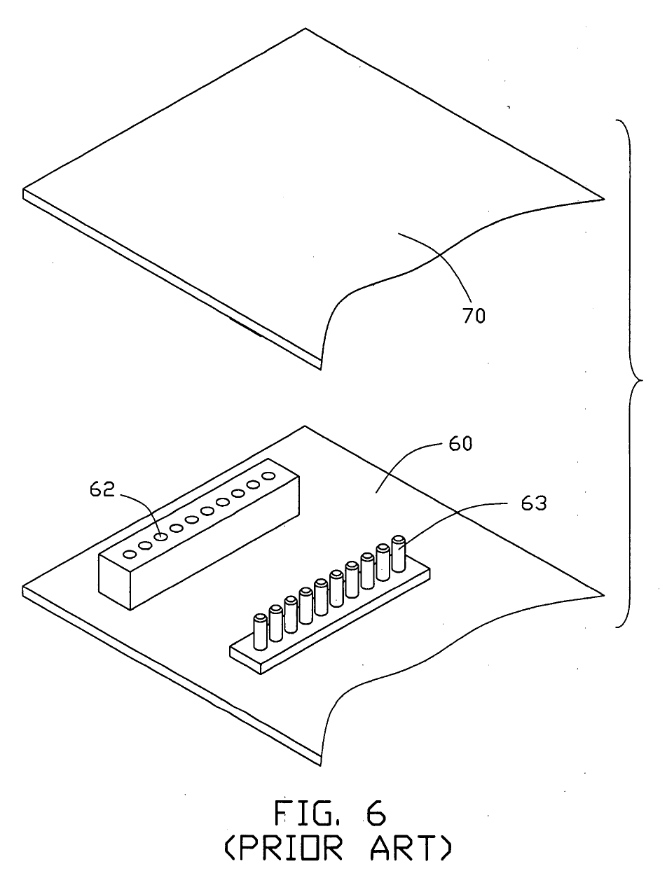

FIG. 5 discloses a main board 50 in accordance with a fourth preferred embodiment of the present invention. The main board 50 includes two male connectors 51, 52 abutting each other at their long sides. The connectors 51, 52 are respectively arranged on the same surfaces of the main board 50.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments.

We claim:

1. A board to board connector assembly comprising a main board and two secondary boards, wherein the main board comprises two connectors being arranged to abut each other, and each of the secondary boards comprises a connector mating with one of the connectors of the main board.

2. The board to board connector assembly as claimed in claim 1, wherein the connectors of the main board abut each other at their short sides.

3. The board to board connector assembly as claimed in claim 2, wherein the connectors of the main board are arranged at different opposite surfaces of the main board.

4. The board to board connector assembly as claimed in claim 2, wherein the connectors of the main board are arranged at a same surface of the main board.

5. The board to board connector assembly as claimed in claim 1, wherein the connectors of the main board abut each other at their long sides.

6. The board to board connector assembly as claimed in claim 5, wherein the connectors of the main board are arranged at different opposite surfaces of the main board.

7. The board to board connector assembly as claimed in claim 5, wherein the connectors of the main board are arranged at a same surface of the main board.

8. A board to board connector assembly comprising a main board and two secondary boards, wherein the main board comprises two connectors abutting each other and being arranged at two opposite surfaces of the main board, and each of the secondary boards comprises a connector mating with one of the connectors of the main board.

9. The board to board connector assembly as claimed in claim 8, wherein the connectors of the main board abut each at their short sides.

10. The board to board connector assembly as claimed in claim 8, wherein the connectors of the main board abut each at their long sides.
